(19) United States
(12) Patent Application Publication
(10) Pub. No.: US 2016/0314483 A1
(43) Pub. Date: Oct. 27, 2016

(54) GROUPING OF ENTITIES FOR DELIVERY OF TANGIBLE ASSETS

(71) Applicant: Tata Consultancy Services Limited, Mumbai (IN)

(72) Inventor: Jeisobers THIRUNAVUKKARASU, Chennai (IN)

(73) Assignee: Tata Consultancy Services Limited, Mumbai (IN)

(21) Appl. No.: 15/055,158

(22) Filed: Feb. 26, 2016

(30) Foreign Application Priority Data
Apr. 22, 2015 (IN) 1639/MUM/2015

(51) Int. Cl. G06Q 30/02

(52) U.S. Cl. CPC G06Q 30/0204

(57) ABSTRACT

The embodiment of the present disclosure relates to a processor implemented system and method for grouping of the plurality of entities for delivery of tangible assets. The system groups entities based on identified parameters relevant to an outcome of the grouping, data points on the various instances of the identified parameters with each data point comprising of information corresponding to an identified parameter, standardization of the data points, determination of weightage for the identified parameters and associating weightage to the standardized data points.

### PRIORITY CLAIM

This U.S. patent application claims priority under 35 U.S.C. §119 to: India Application No. 1639/MUM/2015, filed on Apr. 22, 2015. The entire contents of the aforementioned application are incorporated herein by reference.

### TECHNICAL FIELD

This disclosure relates generally to entities grouping systems, and more particularly to a computer implemented system and method for grouping of a plurality of entities.

### BACKGROUND

In past few years there has been an exponential development of ability to capture and process large amount of information in various sectors e.g., research data in pharmaceutical industry, data on consumers behaviour, data on consumer preferences, real time data from systems. Hence generation of large amount of useful information and the ability to aggregate, interpret and harness this information has led to newer opportunities, approaches and technologies to manage businesses with higher efficiencies.

In most industries, organizations and associations, and in specific the products and services industries, there has been an important need to be able to position and target products and/or services to a set of customers or beneficiaries with the most potential for success. Hence there has been a strong correlation between success and the appropriate positioning of products and/or services.

Industries, organizations and associations follow grouping of customers, products, services, teams or stores based on various kinds of available data points. The success of above task depends on the quality of groups derived to address the targeted objective. The quality of the resulting groups is measured in terms of similarity and dissimilarity of the constituents of the group, based on predetermined criteria. Quite often the groups so formed are heterogeneous on the desired metrics and hence may not offer a focused group for targeting products or services.

Accordingly there is a need for system and method for creation of more homogenous groups of entities.

Hence, it would be critical if a system can enable the user to determine grouping based on a set of parameters of relevance to the outcome and control the selection and impact of the parameters in a way that leads to grouping with improved potential to achieve the targeted outcome.

### SUMMARY

Embodiments of the present disclosure present technological improvements as solutions to one or more of the above-mentioned technical problems recognized by the inventors in conventional systems. For example, in one embodiment, the present disclosure envisages a computer implemented system and method for grouping of entities for delivery of tangible assets, considering on one or more parameters identified based on their relevance to the targeted outcome, with an ability to attribute importance to each of the identified parameters. The delivery of tangible assets (also referred herein as products and/or services) is then based on the entities so identified by this grouping. The terms ‘tangible assets’ and ‘products and/or services’ are interchangeably used herein.

The system comprises a database to store data points on the entities, data points on the identified parameters, data points about the various instances of the identified parameters with each data point comprising of information corresponding to an identified parameter, data points on the standardization ranges, the standardized data points, data points on the ranking of identified parameters, data points on the measure critical to the outcome, data points on the correlation between each of the identified parameters and the measure critical to the outcome, data points on the weightage, data points with the corresponding weightage associated, and data points on the grouping of the entities.

Input modules to accept the identified parameters, the data points about the various instances of the identified parameters with each data point comprising of information corresponding to an identified parameter, standardization ranges, standardized data points, ranking of the identified parameters, measure critical to the outcome and weightage associated data points. A grouping module configured to determine grouping of the entities incorporating importance by means of weightages to be attributed to each of the identified parameters, based on correlation or ranking of the identified parameters. On a continuous basis, to cater to the impact on the data points as an outcome of the grouping, the system would also periodically re-determine the grouping of the entities. The data points considered in such subsequent grouping will then be a mix of the earlier data points as well as the subsequent data points received, The grouping so derived is used for delivery of products and/or services.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a schematic diagram of a system for grouping of entities based on targeted outcome, in accordance with an embodiment of the present disclosure;

FIG. 2 illustrates a flow diagram ill strafing a method of grouping of entities based on a targeted outcome, in accordance with an embodiment of the present disclosure;

FIG. 3 illustrates a list of identified parameters in accordance with an embodiment of the present disclosure;

FIG. 4 is a table view that illustrates a plurality of values of store sales data points in accordance with an embodiment of the present disclosure;

FIG. 5 is a table view that illustrates values of weightages for each identified parameter when correlation data points are available in accordance with an embodiment of the present disclosure;

FIG. 6 is a table view that illustrates values of weightages for each identified parameter based on ranking of the identified parameters in accordance with an embodiment of the present disclosure;

FIG. 7 is a table view that illustrates data points for each of the identified parameters in accordance with an embodiment of the present disclosure;

FIG. 8 is a table view that illustrates a set of standardized data points in accordance with an embodiment of the present disclosure;

FIG. 9 is a table view that illustrates a set of standardized data points with the corresponding weightage based on correlation, associated in accordance with an embodiment of the present disclosure;

FIG. 10 is a table view that illustrates grouping of retail outlets based on identified parameters, the standardization and the associated weightage in accordance with an embodiment of the present disclosure;

FIG. 11 illustrates the distribution of an identified parameter ‘Average Household Income’, over the grouping derived using weightage for data points on the various instances of Average Household Income, in accordance with an embodiment of the present disclosure; and

FIG. 12 illustrates the distribution of an identified parameter ‘Average Household Income’, over the grouping derived without using weightage for data points on the various instances of Average Household Income, in accordance with an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

A computer implemented system and method to group entities for delivery of tangible assets, based on targeted outcome, using at least one identified parameter, the data points of the various instances of the identified parameters with each data point comprising of information corresponding to an identified parameter, standardization of the data points, weightage determination for the identified parameters and association of weightage to the corresponding standardized data points, will now be described with reference to the embodiment shown in the accompanying drawings.

The embodiments described herein do not limit the scope and ambit of the present disclosure. The embodiments herein and the various features and advantageous details thereof are explained more fully with reference to the non-limiting embodiments that are illustrated in the accompanying drawings and detailed in the following description. The description relates purely to the examples and preferred embodiments of the disclosed system and its suggested applications. Descriptions of well-known parameters and processing techniques are omitted so as to not unnecessarily obscure the embodiment herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As used herein, the term “targeted outcome” refers to the purpose of the grouping of entities. For example one purpose could be in telecommunications industry, to form group of customers with certain similar characteristics based on which a particular calling plan could be offered to the customers in that group.

As used herein, the term “identified parameter” refers to parameters identified for the grouping, that are directly relevant to the targeted outcome of grouping the entities.

As used herein, the term “weightage” refers to the importance of the identified parameter to the outcome when compared with other identified parameters being considered.

As used herein, the term “notionally common scale” refers to use of one range of numbers or one scale, for data having different ranges. For example population data may be available in units of millions while income may be in units of thousands. In such cases a scale of say one to one hundred may be considered as one possible notionally common scale. Similarly for the same data a scale of zero to one can also be taken as a notionally common scale,

As used herein, the term “standardized data points” refers to adjusting the various instances of the raw data points of the identified parameter, obtained on different scales, to a notionally common scale.

As used herein, the term “associated” refers to influencing the standardized data points by multiplying the standardized data points with the weightage of an identified parameter leading to ‘weightage associated data points’.

As used herein, the term “entity” refers to objects that need to be grouped. For example entities could be a set of stores in the retail industry, or as another example entities could be a set of routes in the transportation industry, or as another example set of customer in telecommunications industry.

As used herein, the term “grouping” refers to forming sets of entities that have homogeneous characteristics for at least a sub set of identified parameters that are relevant to the targeted outcome of grouping the entities.

As used herein, the term “internal data points” refers to data points obtained from sources internal to an organization (e.g., data points related to sales).

As used herein, the term “spread of grouping mean” refers to spread of the group mean across groups i.e., a higher spread will indicate a larger variance.

As used herein, the term “interquartile range” refers to the difference between (i) the middle value between the smallest value and the median of the ranked data points and (ii) the middle value between the median and the highest value of the ranked data points.

As used herein, the term “measure critical to the outcome” refers to an aspect that is an important indicator of the success of the outcome of the grouping. For example in the context of grouping of subscribers in the telecommunication industry, average revenue per user, can be considered as an example of such a measure. Similarly in the context of formation of a sporting team, the measure can be number of instances of winning in the sport or in the retail industry it could be sales data points for stores.

As used herein, the term “tangible assets” refers to products and/or services to be delivered to private and public sector entities such as but not limited to financial institutions, retail outlets, government bodies, sporting teams and educational institutions.

As used herein, the term “industries” refers to industries, organizations, and associations in both private and public sectors. The term “industries” and organizations and/or associations are interchangeably used herein.

As used herein, the term “raw data points” refer to data points, as obtained from the various sources, prior to making any changes to them.

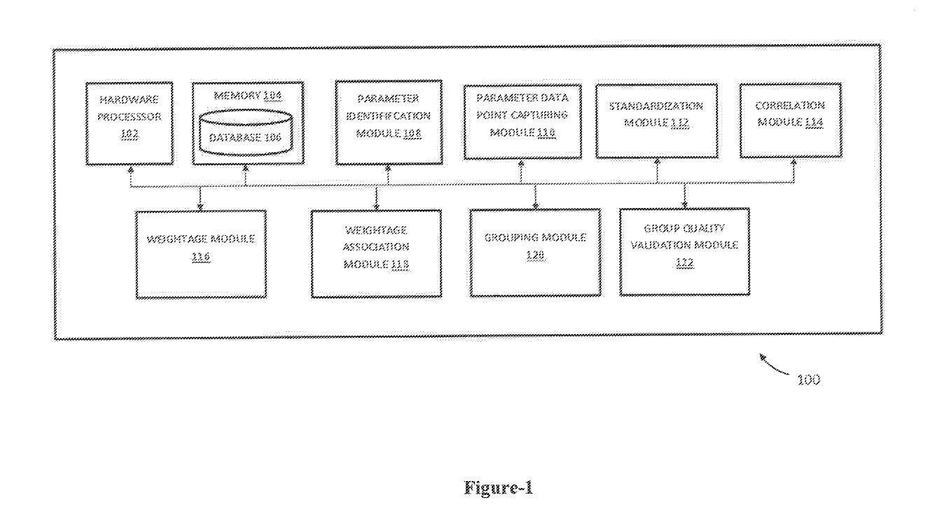

FIG. 1 is a block diagram of an Entity Grouping system 100 according to an embodiment of the present disclosure. The entity grouping system 100 includes a hardware processor 102, a memory 104 storing instructions and a database 106, a parameter identification module 108, a parameter data point capturing module 110, a standardization module 112, a correlation module 114, a weightage module 116, a weightage association module 118, a grouping module 120 and a group quality validation module 122. The hardware processor 102 is configured by the instructions to execute the parameter identification module 108, the parameter data point capturing module 110, the standardization module 112, the correlation module 114, the weightage module 116, the weightage association module 118, the grouping module 120 and the group quality validation module 122.

The database 106 stores data points specific to the entities, data points specific to the identified parameters, data points specific to the various instances of the identified parameters with each data point comprising of information corresponding to an identified parameter, data points specific to the standardization ranges, the standardized data points, data points specific to the ranking of the identified parameters, data points specific to the measure critical to the outcome, data points specific to the correlation between each of the identified parameters and the measure critical to the outcome, data points specific to the weightage, data points with the corresponding weightage associated, and data points specific to the grouping of the entities.

The identified parameters and their various instances of data points are selected from a group comprising, but are not limited to, financial data points, demographic data points, personal data points, data points related to subscription and usage of one or more services, and a combination thereof, etc. The one or more sources for obtaining data points of the various instances of the identified parameters are selected from a group comprising, but are not limited to, one or more telecommunication industries, one or more retailers, one or more medical institutions, one or more financial institutions, one or more sporting events, in one example embodiment, Sources for data points on the measure critical to the outcome can also be internal data sources (e.g., from sales department within an organization to obtain sales data points of the organization).

The parameter identification module 108 identifies one or more parameters, based on a selection, that are to be considered for grouping of the entities. The identified parameters are considered to be directly relevant to the targeted outcome of grouping the entities.

The parameter data point capturing module 110 captures multiple data points related to the various instances of the identified parameters as defined in the parameter identification module 108. These data points form one among the inputs towards grouping of the entities. The data points can be obtained from multiple data sources such as networks and, systems internal as well as external to the organization. In one example embodiment, for an entity being stores in a retail chain, data points of relevance, can comprise data points related to age, household income levels, ethnicity, population density etc., of residents in the vicinity (or in close proximity) of each store. Hence, the age groups, the household income levels, the ethnicity, the population density, etc. may be the identified parameters. In one example embodiment, data points used in determining correlation with the identified parameters can be internal data points comprising of the sales data points of a particular commodity at each store in the chain.

In another example embodiment, grouping can be applicable for formation of team for a gaming activity such as baseball, basketball, cricket etc., from a set of available players. The need in such a grouping will be for homogeneity in certain characteristics (e.g., selection criteria) of the team like players with high scoring averages, players with high physical characteristics like height, annual fees of players etc, Hence these will be the identified parameters for grouping of the players into team.

Since the data points on the various instances of the identified parameters are obtained from multiple data sources, and are in multiple ranges, the standardization module 112, adjusts the data points to notionally common scale to obtain standardized data points. The standardized data points can be locally stored in the database 106 or can be computed and accessed on the fly, without storing in the database 106. As an example the household income data points can have a wide range say from Ten Thousand to Ten Iacs, and as part of standardization the household income data points would be adjusted to be within a range of Zero to One giving standardized data points. Hence each of data points will be standardized. Standardization of the data points is done in accordance with the equation:

xstdij=(xij−mini/maxi−mini)

where

xstdij—standardized value of jth instance of the data point of ith identified parameter

xij—value of jth data point of ith identified parameter

mini—minimum value of ith identified parameter

maxi—maximum value of ith identified parameter

where ‘i’ is a natural number ranging from 1, 2, 3, . . . m

where ‘j’ is a natural number ranging from 1, 2, 3, . . . n

In other words, the data points are standardized based on a ratio of (i) a difference of value of jth instance of the data point of ith identified parameter and minimum value of ith identified parameter (ii) a difference of maximum value of ith identified parameter and minimum value of ith identified parameter, where ranges from 1 to m and ‘j’ ranges from 1 to n, giving standardized data points.

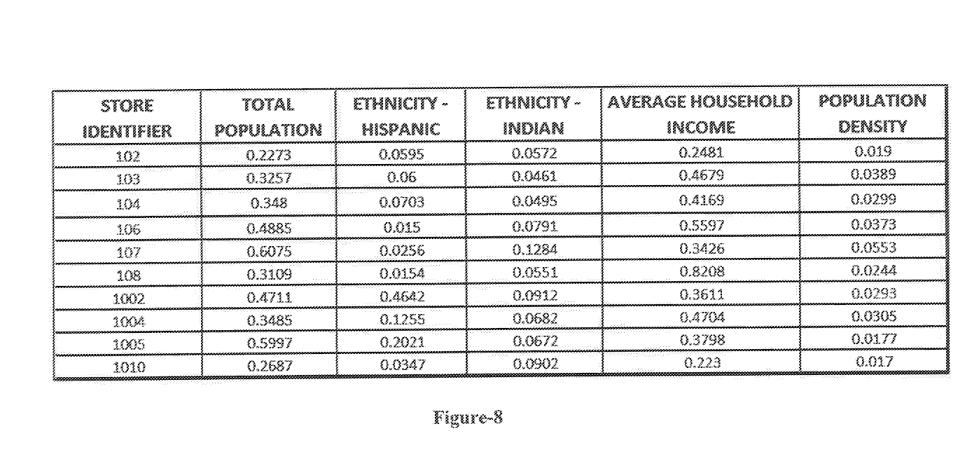

FIG. 8 with reference to FIG. 1, gives a sample representation of standardized data points in accordance with an embodiment of the present disclosure.

The correlation module 114 determines a correlation between each of the identified parameters and the measure critical to the outcome. As an example, in the case of retail industry with stores being the entity for grouping, sales data points can be considered to be important to determine correlation with each of the identified parameters. As an example, using standard statistical formulae, correlation is determined between data points of sales of each store and an average household income of households around the corresponding store. The correlation data points can be locally stored in the database 106 or can be computed and accessed on the fly, without storing in the database 106.

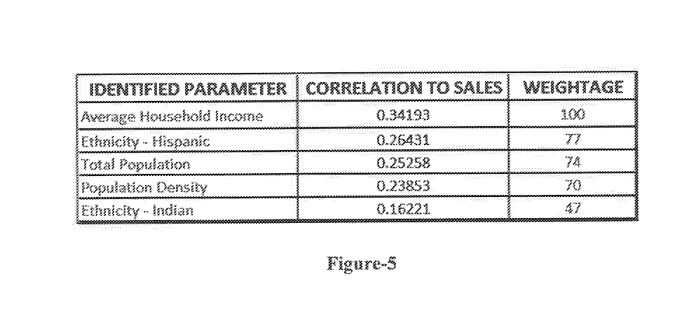

FIG. 5 with reference to FIG. 1, gives a sample representation of computation of correlation described above in accordance with an embodiment of the present disclosure.

For each of the identified parameters, the influence on the grouping of the entities or importance can be controlled by assigning a weightage, The weightage module 116 determines the weightage for each of the identified parameters. Weightage can be determined based on (i) a correlation between each of the identified parameters and the measure critical to the outcome, or (ii) based on ranking of the identified parameters, The weightage data points can be locally stored in the database 106 or can be computed and accessed on the fly, without storing in the database 106.

When the correlation data points between each of the identified parameters and the measure critical to the outcome are available, the weightage module 116 determines the weightage for each of the identified parameters based on the identified parameter's correlation with the measure critical to the outcome. An identified parameter with the highest correlation is given the maximum weightage (wtₘₐₓ) and considered as an upper bound to assign a relative weightage to the other identified parameters. Any numeric value can be fixed as maximum weightage (e.g., 100). Weightage to the subsequent identified parameters is derived in accordance with the equation:

wtᵢ=(wtₘₐₓ/rₜ)*rᵢ

where

wtᵢ—Weightage to i^{th} identified parameter

wtₘₐₓ—Maximum weightage

rₜ—Maximum Correlation value from among all identified parameters

rᵢ—Correlation value of i^{th} identified parameter

In other words, the weightage is obtained based on a product of the correlation value of i^{th} identified parameter and a ratio of (i) maximum weightage i.e., weightage assigned to the identified parameter with the highest correlation (ii) maximum correlation value from among all identified parameters.

FIG. 5 with reference to FIGS. 1 through 4, gives a representation of computation of weightage by the approach based on the correlation described above in accordance with an embodiment of the present disclosure.

In another scenario, the weightage module 116 determines the weightage for each of the identified parameters based on a rank assigned to the each of the identified parameters based on the impact of the identified parameter on the desired outcome, leading to ranked identified parameters.

If there are ‘m’ identified parameters comprising m₁, m₂, m₃ . . . , mₙ, then the first rank i.e., rank ‘1’ is attributed to an identified parameter with the most impact on the desired outcome and the last rank i.e., rank ‘m’ will be assigned to the identified parameter with the least impact on the desired outcome. The identified parameter with the first rank is given maximum weightage wtₘₐₓ. Any numeric value can be fixed as maximum weightage (e.g., 100). Weightage for the identified parameter with s^{th} rank is derived in accordance with the equation:

wtᵢ=wtₘₐₓ/s

where

wtᵢ—Weightage of i^{th} identified parameter

wtₘₐₓ—maximum weightage

s—Rank of the identified parameter (s=1, 2, 3, . . . m)

In other words, the weightage for each identified parameter is obtained based on a ratio of (i) maximum weightage and (ii) rank of the identified parameter,

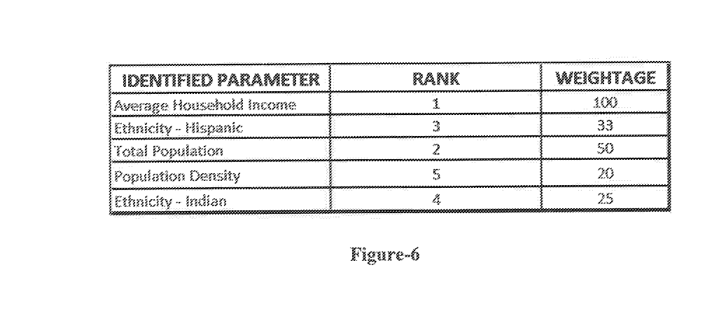

FIG. 6 with reference to FIGS. 1 through 5, gives a sample representation of computation of weightage by the approach described above based on ranking of identified parameters in accordance with an embodiment of the present disclosure.

The weightage association module 118 associates weightages to the standardized data points, leading to the weightage associated data points, in accordance with the equation:

xwtᵢⱼ=xstdᵢⱼ*wtᵢ

where

xwtᵢⱼ—weightage associated value of j^{th} instance of the data point of i^{th} identified parameter

xstdᵢⱼ—standardized value of j^{th} instance of the data point of i^{th} identified parameter

wtᵢ—Weightage of the i^{th} identified parameter

In other words, the weightage associated value of j^{th} instance of the data point of i^{th} identified parameter is obtained based on a product of (i) a standardized value of j^{th} instance of the data point of i^{th} identified parameter and (ii) weightage of the i^{th} identified parameter. The weightage associated data points can be locally stored in the database 106 or can be computed and accessed on the fly, without storing in the database 106.

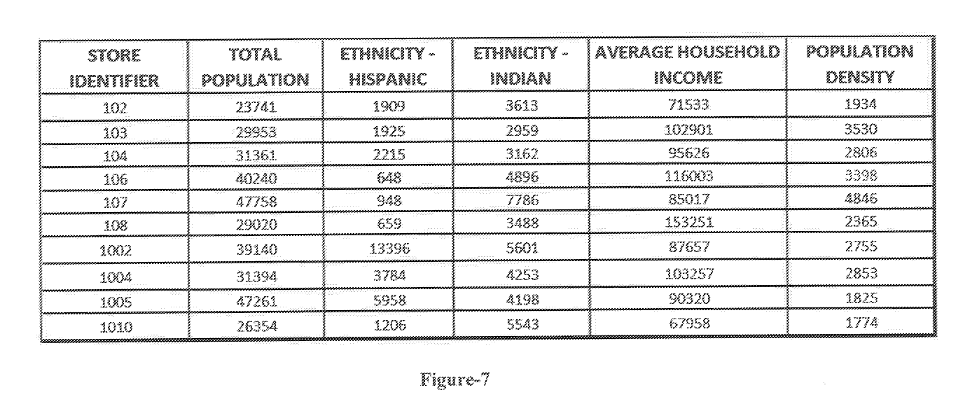

FIG. 7 with reference to FIG. 1 through 6, gives a sample representation of the raw data points for the identified parameters in accordance with an embodiment of the present disclosure.

FIG. 8 with reference to FIG. 1 through 7, gives the standardized representation of the raw data points of FIG. 7 in accordance with an embodiment of the present disclosure.

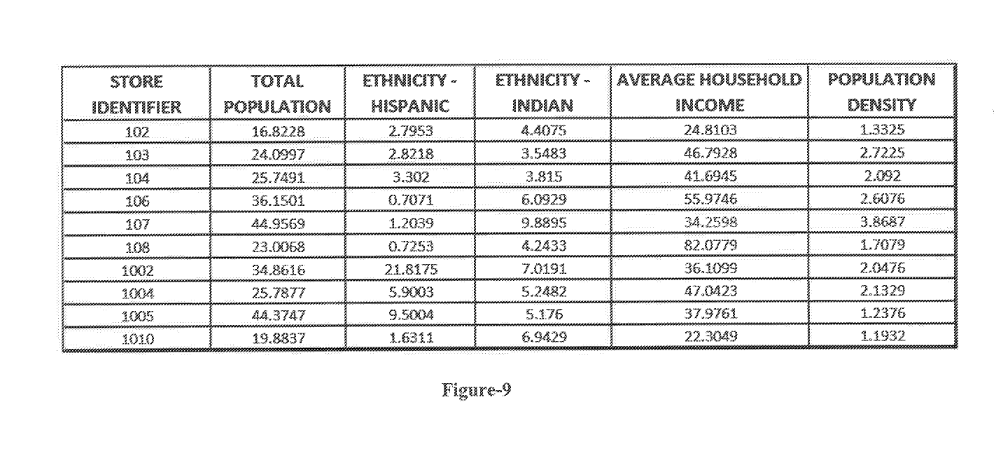

FIG. 9 with reference to FIG. 1 through 8, gives a sample representation of association of weightage to each of the data points, leading to weightage associated data points in accordance with an embodiment of the present disclosure.

Based on the above weightage associated data points, the grouping module 120 forms groups of entities. In one embodiment the grouping is done using ‘K means clustering with Euclidean distance’.

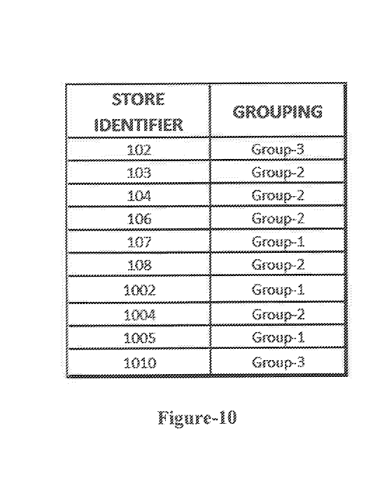

FIG. 10 with reference to FIG. 1 through 9, gives a sample representation of grouping of the entities using weightage associated data points in accordance with an embodiment of the present disclosure.

The group quality validation module 122 determines the quality of the groups formed, In one embodiment the quality is determined using ‘Calinksi-Harabasz (CH) Index’.

Higher value of ‘CH index’ indicates an optimal grouping of the entities. To have better visibility on the effect of individual weightage of each identified parameter, additional measures such as spread of grouping mean and interquartile range are also considered.

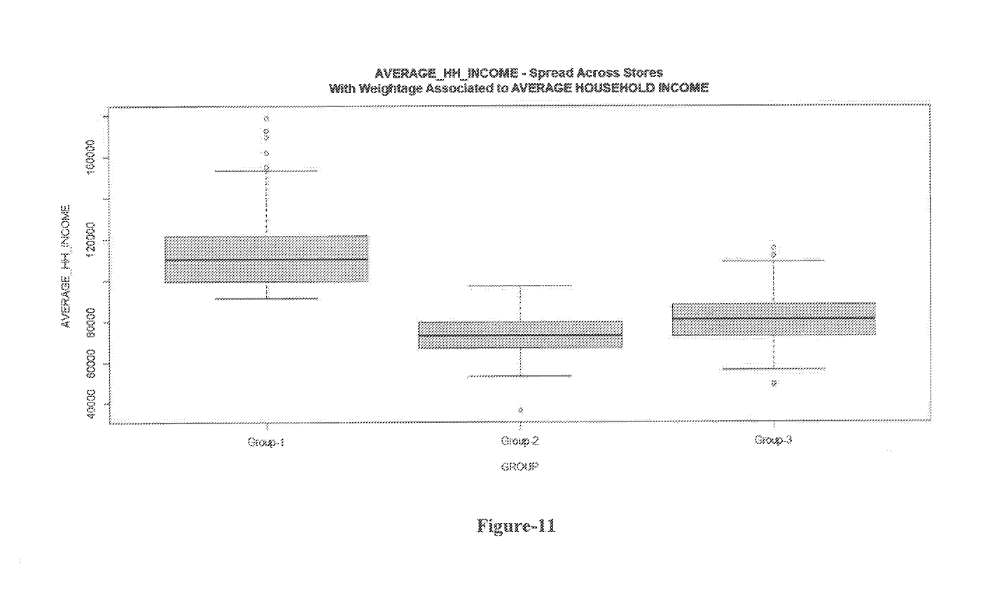

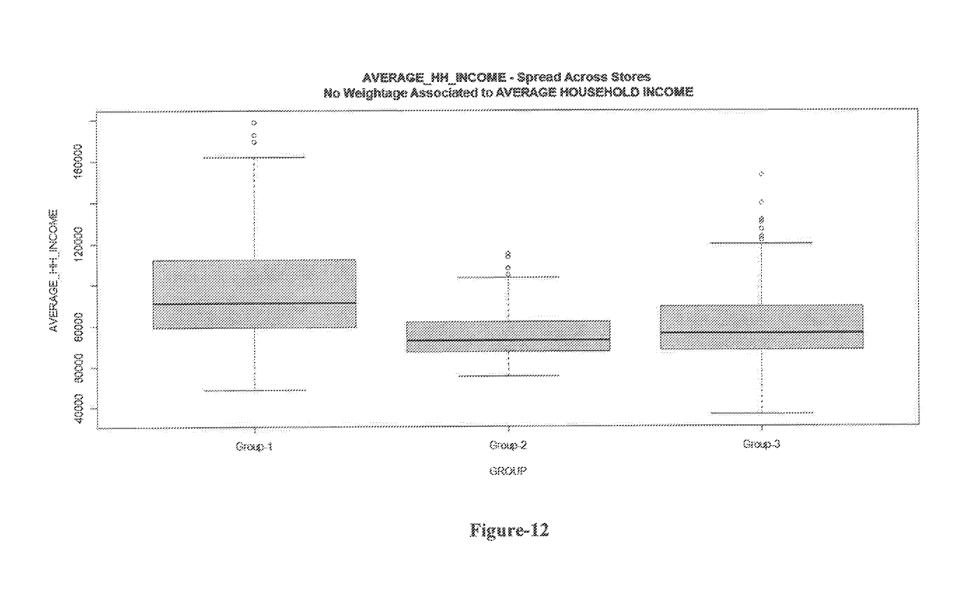

Similarity criteria: The interquartile range shows the similarity measure within the group. The similarity criteria need to be as less as possible, in a preferred embodiment. In FIGS. 11 and 12, the length of box plot shows the similarity criteria and the length of box plot is lesser in the graphical representation in FIG. 11 as compared to the graphical representation in FIG. 12. Both of these indicate that there is an increase in the similarity within the group with respect to the identified parameter ‘Average household income’ by considering a targeted outcome oriented identified parameters with weightage.

Dissimilarity criteria:—The spread of grouping mean across the groups show the dissimilarity criteria and the spread of grouping mean across the groups needs to be as high as possible. The spread of grouping mean across the groups is higher with weightage as shown in FIG. 11 as compared to without weightage as shown in FIG. 12. In FIGS. 11 and 12, the spread of grouping mean across the box plot shows the dissimilarity criteria and spread of grouping mean across the box plot is higher in the graphical representation in FIG. 11 as compared to graphical representation in FIG. 12. Both of these indicate that there is a decrease in the dissimilarity between groups by considering targeted outcome oriented identified parameters with weightage.

Based on the groups formed, the system 100 continues to obtain and process data points of the various instances of the identified parameters with each data point comprising of information corresponding to an identified parameter. This continuous receipt of these data points and the associated redetermination of the grouping results in a continuous feedback on the grouping and hence enables reconsidering of the grouping for furthering the target objectives. In other words, at least a subset of the plurality of data points are continuously received for a plurality of entities that are being (or to be) grouped for a subsequent grouping of entities, wherein the subsequent groups of entities comprise at least in part entities from the groups of entities.

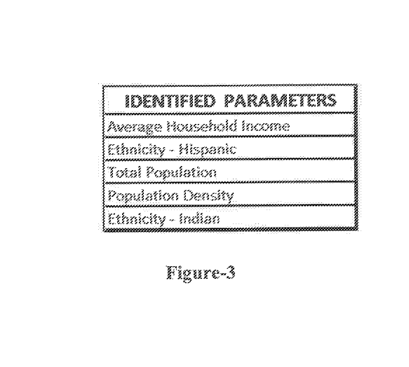

Although, the example below and FIGS. 3 to 10 are depictions based on data points related to retail industry, it is to be understood for a person skilled in the art that the data points and the implementation is not limited to the retail industry.

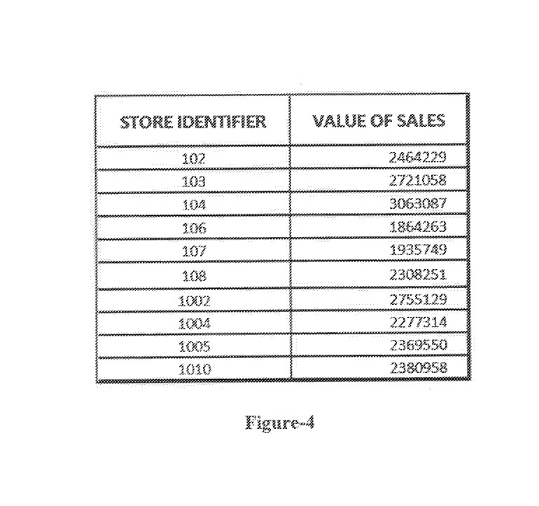

The identified parameters for this example are shown in FIG. 3. In this analysis a total raw data point count of 938 records have been considered for grouping the entities, out of which, a representative subset of 10 data points are depicted in the FIGS. 4 to 10.

In one example embodiment, for a retail chain, the entity for grouping can be stores in the chain. One of the targeted outcomes can be to identify the group of stores best suited for positioning of toys. The inputs for this grouping would be considerations like (i) residents of certain ethnicity have a higher tendency to purchase toys and also the fact that (ii) residents of higher household incomes have a higher tendency to purchase toys.

In such a scenario the parameters of relevance, may comprise of average household income and ethnicity in terms of number of residents who are Hispanics or Indians. Additional aspects could be population density, total resident population in the vicinity of each store etc. Internal data points can comprise of the sales data points of each store in the chain. FIG. 3 illustrates such a sample representation of identified parameters in accordance with an embodiment of the present disclosure.

FIG. 4 illustrates a sample representation of value of sales data points by store, used to determine correlation with the identified parameters in accordance with an embodiment of the present disclosure. The value can be in currencies like INR, USD etc. As depicted in FIG. 4, a first store in a retail chain is identified by a store identifier 102, and corresponding value of sales is 2464229. Similarly, a second store in the retail chain is identified by a store identifier 103, and corresponding value of sales is 2721058. FIG. 5 represents the correlation between the identified parameters and the sales data points as also the weightage determined for each of the identified parameters based on the correlation in accordance with an embodiment of the present disclosure. As depicted in FIG. 5, an identified parameter is identified by the name ‘Average Household Income’ with a correlation value to sales being 0.34193 and the weightage attributed being 100. Similarly, another identified parameter is identified by the name ‘Ethnicity—Hispanic’ with a correlation value to sales being 0.26431 and the weightage being computed to 77.FIG. 6 represents the weightage determined for each of the identified parameters based on ranking of the identified parameters in accordance with an embodiment of the present disclosure. As depicted in FIG. 6, an identified parameter is identified by the name ‘Average Household Income’ with a ranking of ‘1’ and the weightage attributed being 100. Similarly, another identified parameter is identified by the name ‘Ethnicity—Hispanic’ with a ranking of 3 and the weightage being computed to 33.

FIG. 7 shows a sample representation of the raw data points for the identified parameters in accordance with an embodiment of the present disclosure. As depicted in FIG. 7, the first store in the retail chain is identified by the store identifier 102, with the corresponding total population being 23741, the ‘Ethnicity—Hispanic’ value being 1909, the ‘Ethnicity—Indian’ value being 3613. the ‘Average Household Income’ value being 71533 and the ‘Population Density’ value being 1934. Similarly, the second store in the retail chain is identified by the store identifier 103, with the corresponding total population being 29953, the ‘Ethnicity—Hispanic’ value being 1925, the ‘Ethnicity—Indian’ value being 2959, the ‘Average Household Income’ value being 102901 and the ‘Population Density’ value being 3530. FIG. 8 shows the standardized representation of the raw data points of FIG. 7 leading to standardized data points in accordance with an embodiment of the present disclosure. As depicted in FIG. 8, the first store in the retail chain is identified by the store identifier 102, with the corresponding standardized values, for total population being 0.2273, for ‘Ethnicity—Hispanic’ being 0.0595, for ‘Ethnicity—Indian’ being 0.0572, for ‘Average Household Income’ being 0.2481 and for ‘Population Density’ being 0.019. Similarly, the second store in the retail chain is identified by the store identifier 103, with the corresponding standardized values, for total population being 0.3257, for ‘Ethnicity—Hispanic’ being 0.06, for ‘Ethnicity—Indian’ being 0.0461, for ‘Average Household Income’ being 0.4679 and for ‘Population Density’ being 0.0389. FIG. 9 shows the standardized data points associated with the weightage represented in FIG. 5, leading to weightage associated data points in accordance with an embodiment of the present disclosure. As depicted in FIG. 9, the first store in the retail chain is identified by the store identifier 102, with the corresponding weightage associated data points, for total population being 16,8228, for ‘Ethnicity—Hispanic’ being 2.7953, for ‘Ethnicity—Indian’ being 4.4075, for ‘Average Household Income’ being 24.8103 and for ‘Population Density’ being 1.3325. Similarly, the second store in the retail chain is identified by the store identifier 103, with the corresponding weightage associated data points, for total population being 24.0997, for ‘Ethnicity—Hispanic’ being 2.8218, for ‘Ethnicity—Indian’ being 3,5483, for ‘Average Household Income’ being 46.7928 and for ‘Population Density’ being 2.7225. FIG. 10 shows the grouping of the stores based on the data points in FIG. 9 in accordance with an embodiment of the present disclosure. As depicted in FIG. 10, the first store in the retail chain is identified by the store identifier 102, belongs to the group ‘Group-3’. Similarly, the second store in the retail chain is identified by the store identifier 103, belongs to the group ‘Group-2’.

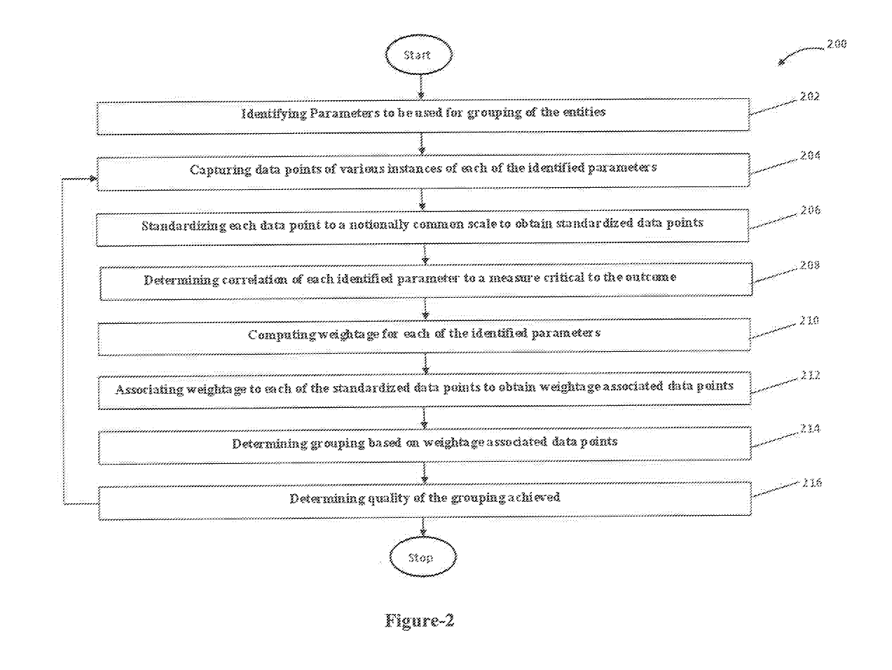

FIG. 2, with reference to FIG. 1, is a flow diagram illustrating a computer implemented system and method for grouping of entities for delivery of tangible assets according to an embodiment of the present disclosure. The method comprising identifying (202), using the parameter identification module 108, parameters to be used for grouping of entities, wherein the identified parameters are directly relevant to the targeted outcome of grouping of entities; capturing (204), using the parameter data point capturing module 110, data points of various instances of each of the identified parameters wherein each data point comprising of information corresponding to an identified parameter; standardizing (206), using the standardization module 112, each data point to a notionally common scale to obtain standardized data points; determining (208), using the correlation module 114, correlation of each identified parameter to a measure critical to the outcome; computing (210), using the weightage module 116, weightage for each of the identified parameters; associating (212), using the weightage association module 118, weightage to each of the standardized data points to obtain weightage associated data points; determining (214), using the grouping module 120, grouping based on weightage associated data points; determining (216), using the group quality validation module 122, quality of the grouping achieved.

The technical advancements of the system envisaged by the present disclosure include the realization of:

A system for delivery of tangible assets based on grouping of entities depending on parameters identified based on their impact on the targeted outcome. The grouping is carried out using standardized data points for the various instances of the identified parameters and in accordance with the weightage attributed to each of the identified parameters impacting the grouping.

A system that analyses and adjusts the grouping of the entities based on the weightage determined by correlation of the identified parameters with measure critical to the outcome or ranking of the identified parameters.

A system which determines highly homogeneous grouping of entities.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A computer implemented method for delivery of tangible assets based on grouping of a plurality entities, the computer implemented method comprising;
identifying, by a hardware processor, one or more parameters relevant to an outcome of grouping of the plurality of entities to obtain one or more identified parameters;
obtaining, by the hardware processor, a plurality of data points from one or more sources, wherein each of the plurality of data points comprises of information corresponding to an identified parameter from the one or more identified parameters;
standardizing, by the hardware processor, the plurality of data points to a notionally common scale to obtain standardized data points;
computing, by the hardware processor, a correlation between each of the one or more identified parameters and a measure critical to the outcome;
computing, by the hardware processor, a weightage of each of the one or more identified parameters based on the correlation;
associating, by the hardware processor, the computed weightage corresponding to each of the one or more identified parameters, to each of the corresponding standardized data points to obtain weightage associated data points; and
grouping, by the hardware processor, the plurality of entities based on the weightage associated data points to obtain a group of entities.

2. The computer implemented method of claim 1, wherein the plurality of data points are standardized based on (i) a value of i^{th} data point of i^{th} identified parameter, (ii) a minimum value of i^{th} identified parameter, and (iii) a maximum value of i^{th} identified parameter.

3. The computer implemented method of claim 1, wherein the weightage is computed based on (i) a maximum weightage, (ii) a maximum correlation value from among all identified parameters, and (iii) a correlation value of i^{th} identified parameter.

4. The computer implemented method of claim 1, wherein each of the identified parameters is ranked based on a relevance to the outcome of grouping of the plurality of entities to obtain ranked identified parameters.

5. The computer implemented method of claim 4, wherein the weightage is computed for each of the ranked identified parameters based on (i) a maximum weightage, and (ii) a rank of a corresponding ranked identified parameter from the ranked identified parameters.

6. The computer implemented method of claim 1, wherein the weightage is associated with each of the standardized data points based on (i) a standardized value of i^{th} data point of i^{th} identified parameter, and (ii) a weightage of i^{th} identified parameter.

7. The computer implemented method of claim 1, wherein the group of entities are obtained for delivery of tangible assets.

8. The computer implemented method of claim 1, wherein at least a subset of the plurality of data points are continuously received for a plurality of entities that are being grouped to form subsequent groups of entities, and wherein the subsequent groups of entities comprise at least in part entities from the groups of entities.

9. A computer implemented system for delivery of tangible assets based on grouping of the plurality of entities, the computer implemented system comprising:
a hardware processor;
a memory that stores instructions and a database, wherein the database comprises a plurality of data points obtained from one or more sources, wherein the data points comprise information corresponding to one or more of the identified parameters, and wherein the hardware processor is configured by the instructions to execute:
a parameter identification module that identifies one or more parameters, relevant to an outcome of grouping of the plurality of entities to obtain one or more identified parameters;
a parameter data point capturing module that obtains a plurality of data points from one or more sources, wherein each of the plurality of data points comprises of information corresponding to an identified parameter from the one or more identified parameters;
a standardization module that standardizes the plurality of data points to a notionally common scale to obtain standardized data points;
a correlation module that computes a correlation between each of the one or more identified parameters and a measure critical to the outcome;
a weightage module that computes a weightage of each of the one or more identified parameters based on the correlation;
a weightage association module that associates the computed weightage corresponding to each of the one or more identified parameters, to each of the corresponding standardized data point to obtain weightage associated data points; and
a grouping module that groups the plurality of entities based on the weightage associated data points to obtain a group of entities.

10. The computer implemented system of claim 9, wherein the standardization module standardizes the plurality of data points based on (i) a value of i^{th} data point of i^{th} identified parameter, (ii) a minimum value of i^{th} identified parameter, and (iii) a maximum value of i^{th} identified parameter.

11. The computer implemented system of claim 9, wherein the weightage module computes the weightage based on (i) a maximum weightage, (ii) a maximum correlation value from among the identified parameters, and (iii) a correlation value of i^{th} identified parameter.

12. The computer implemented system of claim 9, wherein each of the identified parameters is ranked based on a relevance to the outcome of grouping of the plurality of entities to obtain ranked identified parameters.

13. The computer implemented system of claim 12, wherein the weightage module computes the weightage for each of the ranked identified parameters based on (i) a maximum weightage, and (ii) a corresponding ranked identified parameter from the ranked identified parameters.

14. The computer implemented system of claim 9, wherein the weightage association module associates weightage with each of the standardized data points based on (i) a standardized value of j^{th} data point of i^{th} identified parameter, and (ii) a weightage of i^{th} identified parameter.

15. The computer implemented system of claim 9, wherein the group of entities are obtained for delivery of tangible assets.

16. The computer implemented system of claim 9, wherein at least a subset of the plurality of data points are continuously received for a plurality of entities that are being grouped to form subsequent groups of entities, and wherein the subsequent groups of entities comprise at least in part entities from the groups of entities.

17. One or more non-transitory machine readable information storage mediums comprising one or more instructions, which when executed by one or more hardware processors causes to perform a computer implemented method comprising:
identifying, by said one or more hardware processors, one or more parameters relevant to an outcome of grouping of the plurality of entities to obtain one or more identified parameters;
obtaining a plurality of data points from one or more sources, wherein each of the plurality of data points comprises of information corresponding to an identified parameter from the one or more identified parameters;
standardizing the plurality of data points to a notionally common scale to obtain standardized data points;
computing, by the hardware processor, a correlation between each of the one or more identified parameters and a measure critical to the outcome;
computing, by the hardware processor, a weightage of each of the one or more identified parameters based on the correlation;
associating, by the hardware processor, the computed weightage corresponding to each of the one or more identified parameters, to each of the corresponding standardized data points to obtain weightage associated data points; and
grouping, by the hardware processor, the plurality of entities based on the weightage associated data points to obtain a group of entities.

18. The one or more non-transitory machine readable information storage mediums of claim 17, wherein each of the identified parameters is ranked based on a relevance to the outcome of grouping of the plurality of entities to obtain ranked identified parameters.

19. The one or more non-transitory machine readable information storage mediums of claim 17, wherein the group of entities are obtained for delivery of tangible assets.

20. The one or more non-transitory machine readable information storage mediums of claim 17, wherein at least a subset of the plurality of data points are continuously received for a plurality of entities that are being grouped to form subsequent groups of entities, and wherein the subsequent groups of entities comprise at least in part entities from the groups of entities.
